(19) United States
(12) Patent Application Publication
(10) Pub. No.: US 2022/0297240 A1
(43) Pub. Date: Sep. 22, 2022

(54) METHOD FOR ELIMINATING WELD GAPS AND POSITIONAL VARIATION IN WELD ASSEMBLIES

(71) Applicants: John Richard POTOCKI, Armada, MI (US); MAGNA INTERNATIONAL INC., Aurora (CA)

(72) Inventor: John Richard POTOCKI, Armada, MI (US)

(21) Appl. No.: 17/603,698

(22) PCT Filed: Apr. 13, 2020
(86) PCT No.: PCT/US2020/027909

§ 371 Date: Oct. 14, 2021

Related U.S. Application Data
(60) Provisional application No. 62/833,974, filed on Apr. 15, 2019.

(51) Int. Cl. B23K 31/02; B23K 31/10; B23K 31/12; B25J 11/00

(52) U.S. Cl. CPC B23K 31/02; B23K 31/10; B23K 31/12; B25J 11/005; B23K 2101/006

(57) ABSTRACT

A component having a first part and a second part. The first part has a first interface surface and the second part has a second interface surface that is connected to the first interface surface via a bond. A digital profile of the first interface surface is used to shape the second interface surface to fit against the first interface surface with minimal to no gap therebetween before forming the bond. The digital profile is developed by scanning the first part with a scanner and the second part is shape by cutting or milling with a robotic arm that acts in accordance with a digital profile data read by a controller. The two parts are bonded via a weld that is automatically guided by the digital profile.

### CROSS-REFERENCE TO RELATED APPLICATIONS

This PCT International Patent Application claims the benefit of and priority to U.S. Provisional Patent Application Ser. No. 62/833,974, filed Apr. 15, 2019, titled “Method For Eliminating Weld Gaps And Positional Variation In Welded Assemblies,” the entire disclosure of which is hereby incorporated by reference.

### BACKGROUND OF THE INVENTION

### 1. Field of the Invention

The present invention relates to a method of eliminating a weld gap between two parts. More particularly, the present invention relates to a method of accurately measuring an interface surface of one part and shaping a corresponding interface surface of another part.

### 2. Related Art

This section provides background information related to the present disclosure which is not necessarily prior art.

Automobiles, particularly automobile frames cradles and transverse axles, are constructed of a variety of different components that are assembled from individually formed parts by welding or otherwise bonding them together. These individually formed parts are joined together at interface surfaces, which are ideally formed like a puzzle, wherein the profiles of corresponding interface surfaces match together as close as possible. The closer the profiles of opposing interface surfaces generally correlate with improved time and efficiency of assembling of the component. While advancements in technology have resulted in shaping profiles that are relatively accurate, there are still problematic gaps between the two opposing interface surfaces that require additional production steps. For example, traditional attempts to limit or fix already existing gaps between interface surfaces includes bending one part such that the interface surface better aligns with the other part or filling the gap with additional material. However, in addition to the loss of efficiency and worker time, these traditional fixes also result in loss to structural integrity. When one part is bended or warped, for example, it is often accompanied by a required step of piercing holes to compensate for the variation of internal forces. Similarly, difficulties arise when the gap is filled with additional material, this additional material is generally deposited via various welding techniques, such as weave welding and exposes the interface surfaces to a significant amount of additional heat which can affect surrounding microstructure of the part. Moreover, welding additional material to fill a gap also results in poor quality welds, waste of consumables (shielding gas, electricity, and weld wire due to weaving), additional required machinery like a pierce unit, and distortion of the part due to extended exposure to heat.

Accordingly, there is a continuing desire to develop a method of joining two parts wherein an interface surface of one of the parts is accurately profiled to develop a close fit with the other part, resulting in quality welds and strong joints.

### SUMMARY OF THE INVENTION

This section provides a general summary of the disclosure and should not be interpreted as a complete and comprehensive listing of all the objects, aspects, features and advantages associated with the present disclosure.

The subject invention provides a component having a first part and a second part. The first part has a first interface surface and the second part has a second interface surface. The first interface surface and second interface surface are connected to one another via a bond. The first interface surface includes a digital profile used to shape second interface surface to fit against the first interface surface with minimal to no gap therebetween before forming the bond.

The subject invention further provides a method of constructing a component that includes providing a first part having a first interface surface. Scanning the first interface surface and developing a digital profile. Providing a second part having a second interface surface. Using the digital profile, shaping second interface surface in accordance with the digital profile. Contacting the first interface surface and the second interface surface and bonding the first interface surface to the second interface surface.

Further areas of applicability will become apparent from the description provided herein. The description and specific examples in this summary are intended for purpose of illustration only and are not intended to limit the scope of the present disclosure.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1A is a perspective view of a first part having a first interface surface being aligned with a second part having a second interface surface;

FIG. 1B is a perspective view of the first part and second part bonded together at the first and second interface surfaces;

FIG. 2A is a top view of a frame of an automobile that includes a plurality of parts connected to one another at corresponding interface surfaces;

FIGS. 2B and 2C are perspective views of additional automobile components that include several parts connected to one another at corresponding interface surfaces;

FIG. 3A is a cross-sectional view of a component formed of two parts joined at corresponding interface surfaces in accordance with prior art methodology;

FIGS. 3B through 3G are cross-sectional views of various components formed of two parts joined at corresponding interface surfaces in accordance with the subject disclosure;

FIGS. 4A is a cross-sectional view of the first part being digitally profiled with a scanning assembly;

FIG. 4B is a cross-sectional view of the second part having material removed with a shaping assembly in accordance with the digital profile of the first part;

FIG. 4C is a cross-sectional view of the first part and the second part being connected with a welding assembly;

FIG. 4D is a schematic view of an operations circuit controlling the operations of the assemblies illustrated in FIGS. 4A through 4C;

FIG. 5 is table comparing the accuracy of matching interface surfaces between prior art methodologies with those of the subject disclosure;

FIG. 6A is a plan view of a system of developing a digital profile of one part and shaping a second part in accordance with the digital profile data

FIG. 6B is a flow chart of operational steps in accordance with the system of FIG. 6A; and

FIG. 7 is a method chart of developing a digital profile of one part and shaping a second part in accordance with the digital profile data.

### DESCRIPTION OF THE ENABLING EMBODIMENT

Example embodiments will now be described more fully with reference to the accompanying drawings. In general, the subject embodiments are directed to a component formed of two parts joined at corresponding interface surfaces and a method and system of constructing same. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Referring to the Figures, wherein like numerals indicate corresponding parts throughout the views, the component formed of two parts joined at corresponding interface surfaces and a method and system of constructing same are intended for reducing the gap between the corresponding interface surfaces, which have frequented and impaired traditional methodologies.

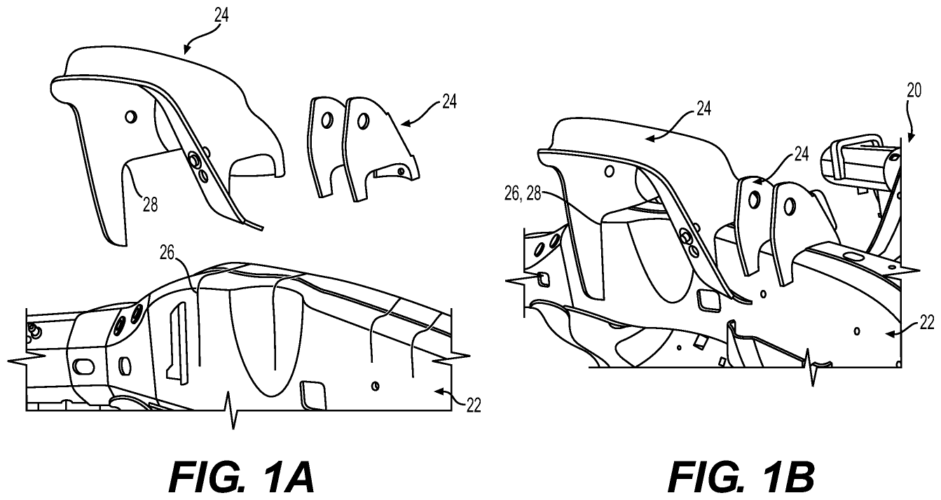

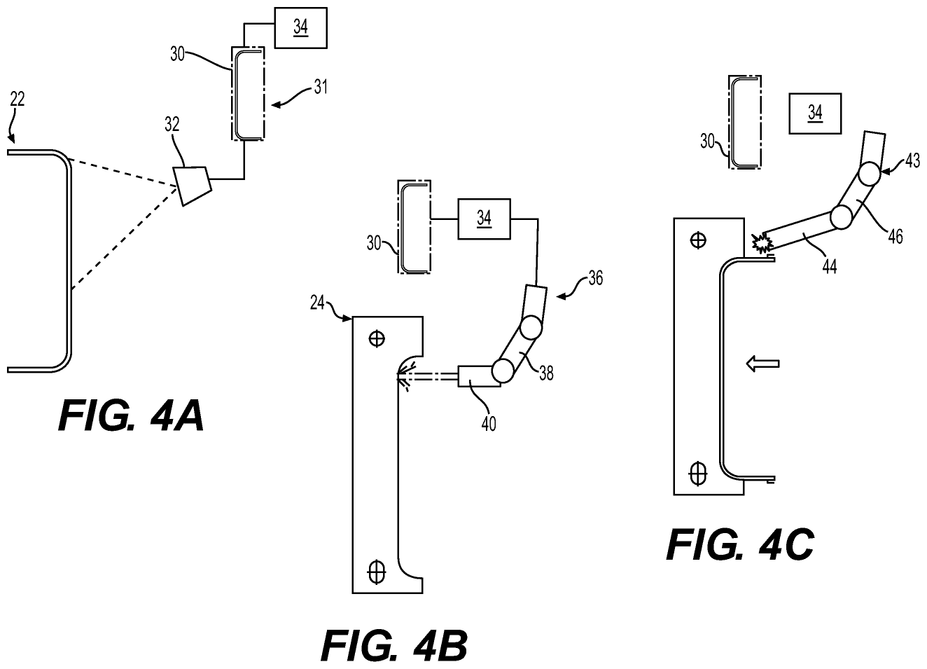

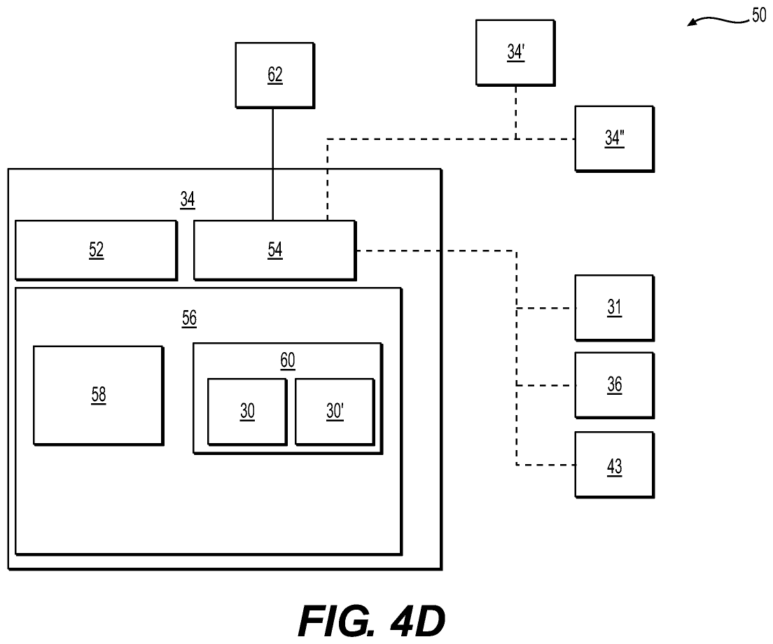

Referring first to FIG. 1A, a component 20 is in the process of being assembled via the connection of a first part 22 and a second part 24. The first part 22 has at least one first interface surface 26 and the second part has at least one second interface surface 28. FIG. 1B illustrates the assembled component 20 wherein the first part 22 is connected to the second part 24. More particularly, the first interface surface 26 is bonded to the second interface surface 28, for example, via welding. The spacing between the first interface surface 26 and the second interface surface 28 is minimal such that the parts 22, 24 can be bonded together with a traditional weld joint, i.e., there is no required additional steps such as weave welding, bending of the parts, or use of other additional materials and/or steps. The close clearance between interface surfaces is preferably under 0.5 mm and is achieved by developing a digital profile 30 (FIG. 4A through FIG. 4C) of either the first interface surface 26 or the second interface surface 28. As will be more fully described in reference to FIGS. 4A through 4C, the digital profile 30 is developed by a scanner 32, for example a laser scanner, a light detection and ranging (LIDAR) sensor, etc. Once the digital profile 30 is developed, a controller 34 uses the digital profile 30 to instruct a shaping assembly 36 to shape the second interface surface 28 to match the first interface surface 26. The shaping assembly 36 preferably includes a robotic arm 38 and a shaping instrument 40, which can utilize at least one of a milling (rotary blades or roughened surface) or cutting functionality (laser or mechanical blades). The same digital profile 30 is also used to adjust a welding path for a welding machine 44, preferably an inert gas welding machine on a second robotic arm 46, to bond the two parts 22, 24 along the interface surfaces 26, 28..

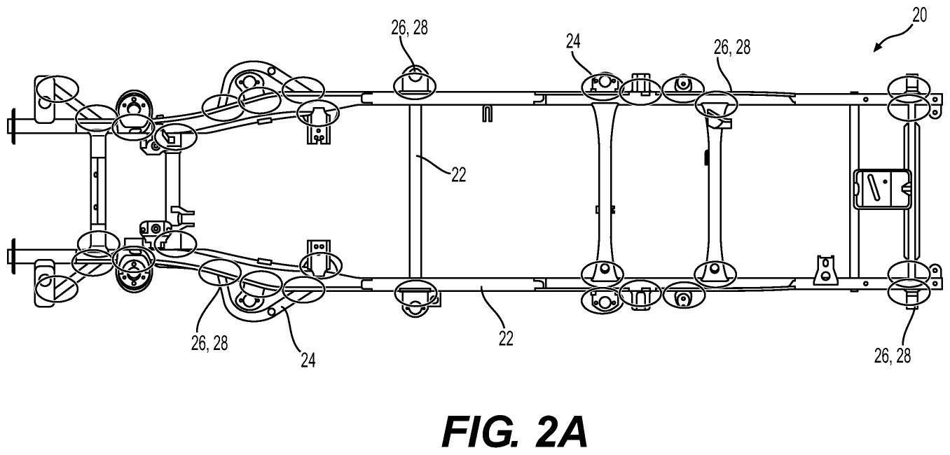

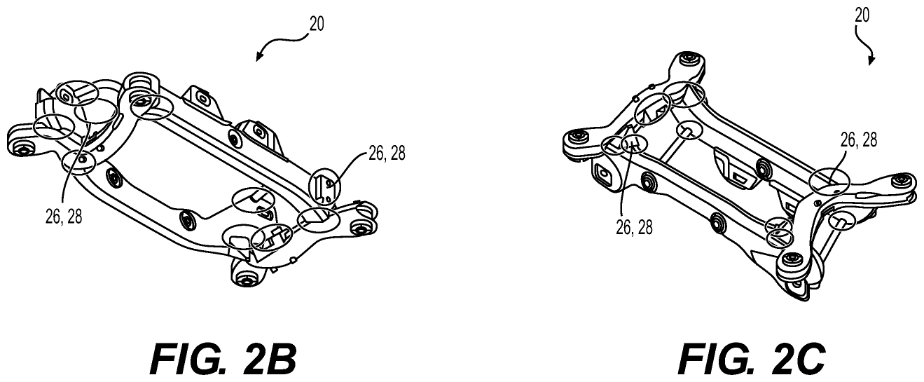

Referring now to FIGS. 2A through 2C, several example components 20 are shown. While not limited thereto, these components are illustrated as various portions of a frame of an automobile that include the connection two or more parts along corresponding interface surfaces. For example, the first part 22 may be chassis side members or cross-members and the second part 24 may be brackets or other component connections.

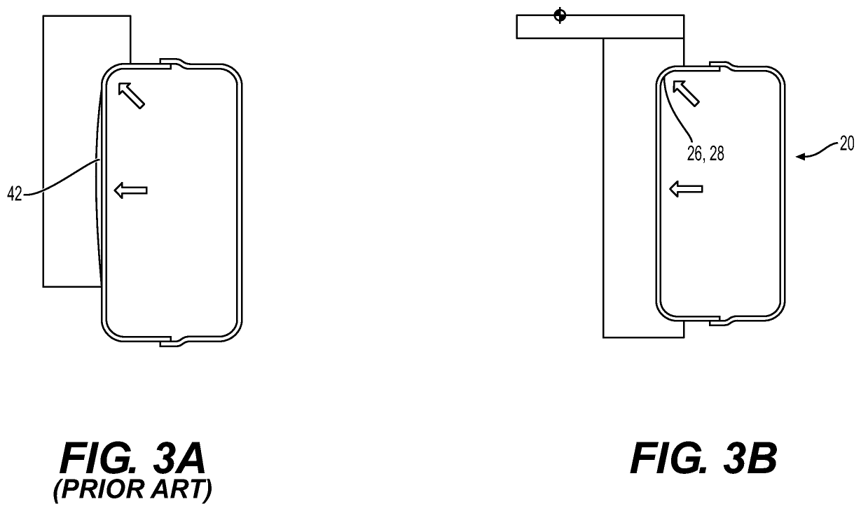

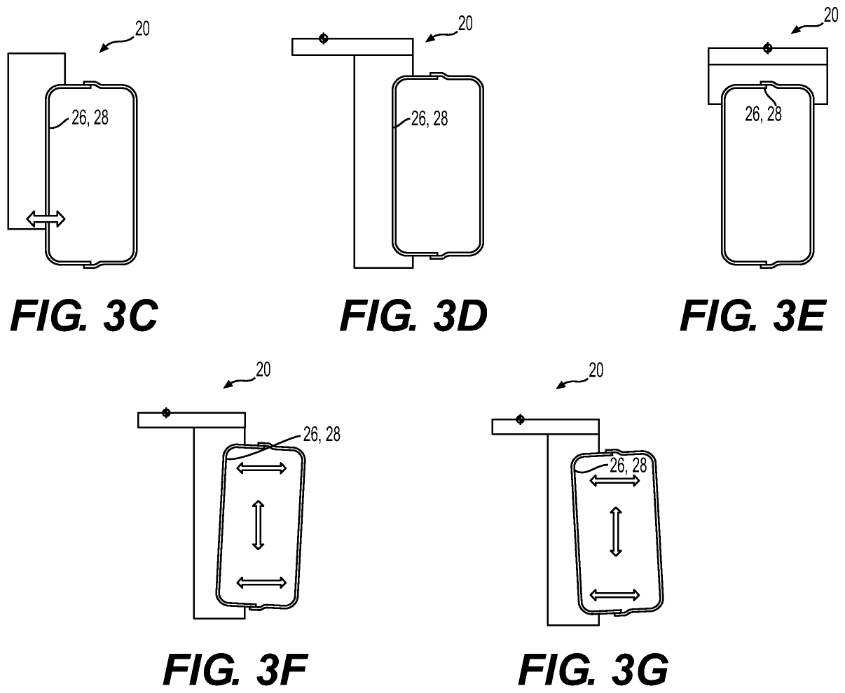

FIG. 3A through 3G are a series of cross-sectional illustrations of a first part 22 being bonded to a second part 24. A gap 42 between parts 22, 24 is shown in FIG. 3A, which illustrates a traditional methodology. Accordingly, the presence of the gap 42 requires additional steps, for example adding additional material to the gap 42 and/or bending the first part 22 along the first interface surface 26. However, FIGS. 3B through 3G are all illustrations of two parts 22, 24 that have undergone certain steps of the present disclosure. More particularly, the first part 22 has a first interface surface 26 that is scanned to develop a digital profile 30. The digital profile 30 includes information that relates to the topography of the first interface surface 26. Information relating to the digital profile 30 is then used by a controller 34 for instructing a shaping component 36 to remove material from the second part 24 and more particularly the second interface surface 28. Material is then removed from the second interface surface 28 until the topography of the first interface surface 26 matches to the topography of the second interface surface 28. Once matched, the two interface surfaces 26, 28 have a minimal to no gap therebetween and can be connected via a standard weld joint or any other bonding techniques. Depending on the component 20, the parts 22, 24 may be required to be fit together in various orientations. FIGS. 3B through 3G illustrate several different orientations between parts 22, 24 that can have an effect on the ideal interface surface 26, 28 topographies or profiles. Arrows throughout these Figures indicate the direction that the two parts 22, 24 are moved relative to one another before they are bonding together.

FIGS. 4A through 4C sequentially show the first part 22 being profiled, the second part 24 being shaped, and the first and second parts 22, 24 being connected. Referring initially to FIG. 4A, the first part 22 is in the process of being scanned by a scanning assembly 31 that includes the scanner 32, for example, a laser scanner. As the scanner 32 scans the first interface surface 26, it develops a digital profile 30 that represents the topography of the first interface surface 26. The digital profile 30 is then used by a controller 34 remove material from the second part 24 to create a matching topography. Removal of material is accomplished via a shaping assembly 36 that includes a shaping instrument 40 and a robotic arm 38 that directs the shaping instrument 40 in accordance with instructions from the controller 34 as shown in FIG. 4B. After an ideal amount of material has been removed from the second part 24, the first interface surface 26 is aligned with the second interface surface 28 and the two parts 22, 24 are joined together and bonded. The step of joining and bonding parts 22, 24 can be completed via a robotic arm and bonding assembly 43, for example a welding machine 44 and even more particularly an inert-gas welding machine. The digital profile 30 is also used by the controller to direct the weld machine 44, for example, via a welding robotic arm 46. In manufacturing settings there may be several identical first parts 22 and second parts 24 such that one digital profile 30 can be used to form and bond multiple different but identically shaped parts 22, 24. Similarly, manual adjustments can be made to the profile 30 that are carried over to subsequent parts.

With reference now to FIG. 4D, a schematic view of an operations circuit 50 is shown. The various elements provided therein allow for a specific implementation. Thus, one of ordinary skill in the art of electronics and circuits may substitute various components to achieve a similar functionality. The operations circuit 50 includes the controller 34. The controller 34 includes a processor 52, a communications unit 54 (for example associated with wired or wireless internet connection), and a memory 56 having machine-readable non-transitory storage. Programs and/or software 58 are saved on the memory 56 and so is profile information 60 obtained via the scanner 32 or elsewhere. The profile information 60 may include digital profile data 30, 30′ of multiple differently shaped parts that can be saved until needed. The processor 52 carries out instructions based on the software 58 and digital profile data 60, for example, providing instructions for scanning, trimming or welding operations. Profile data 60 may also be modified with a user interface 62, for example, to remove slightly more material in order to add adhesive between interface surfaces or to remove slightly less material to form a press-fit. The example circuit 50 may communicate with the scanning assembly 31, the shaping assembly 36, or the welding assembly 43 via the communications unit 54. Alternatively, each of the scanning assembly 31, the shaping assembly 36, and the welding assembly 43 may include a controller 34, 34′, 34″, wherein the first controller 34 is associated with the scanning assembly 31. Moreover, the scanner 32, shaping instrument 40, and welding machine 44 may be placed on the same robotic arm. Movement of the second part 22 into the shaped interface surface may also be completed via a robotic arm that receives instructions from operations circuit 50.

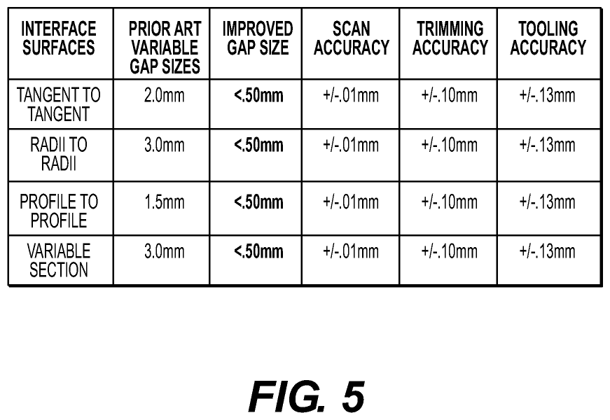

FIG. 5 is table comparing the accuracy of matching interface surfaces between prior art methodologies with those of the subject disclosure. As shown, parts 22, 24 connected via methodologies of the subject disclosure are shown to have a gap smaller than 0.5 mm. More particularly, the scanning accuracy is about 0.01 mm, the shaping and/or trimming accuracy is about 0.1 mm and the tooling accuracy is about 0.13 mm, totaling approximately 0.23 mm loss of accuracy or gap width. As illustrated in the table, the accuracy of fitting two parts 22, 24 in accordance with the subject disclosure is not affected by the shape of the part. For example, in traditional methodologies, when both interface surfaces 26, 28 are radial, the loss of can be upwards to 3 mm. However, by using a digital profile 30, the accuracy is only limited to the machinery used and is thus consistent and highly predictable such that one part can be gloved into the other part.

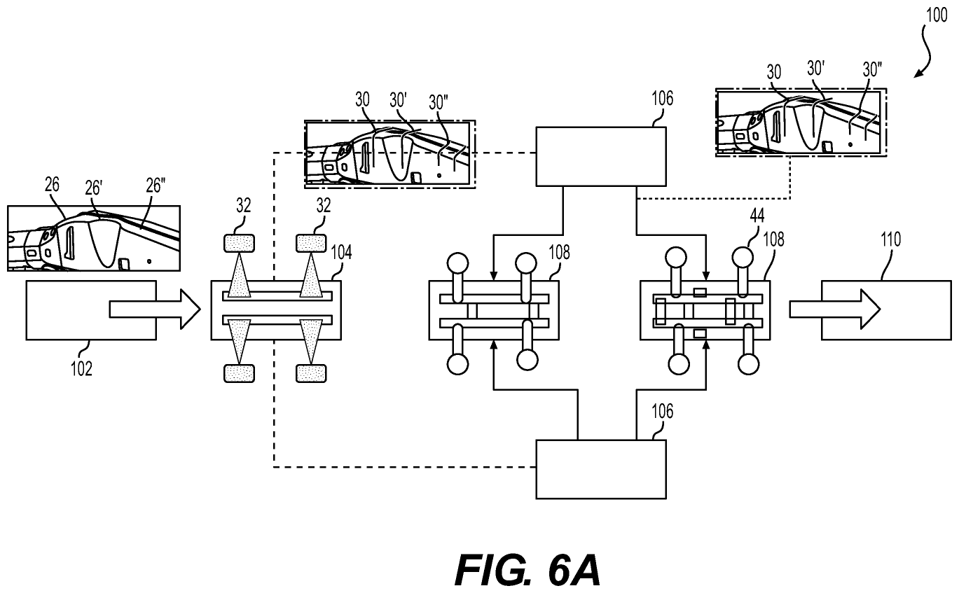

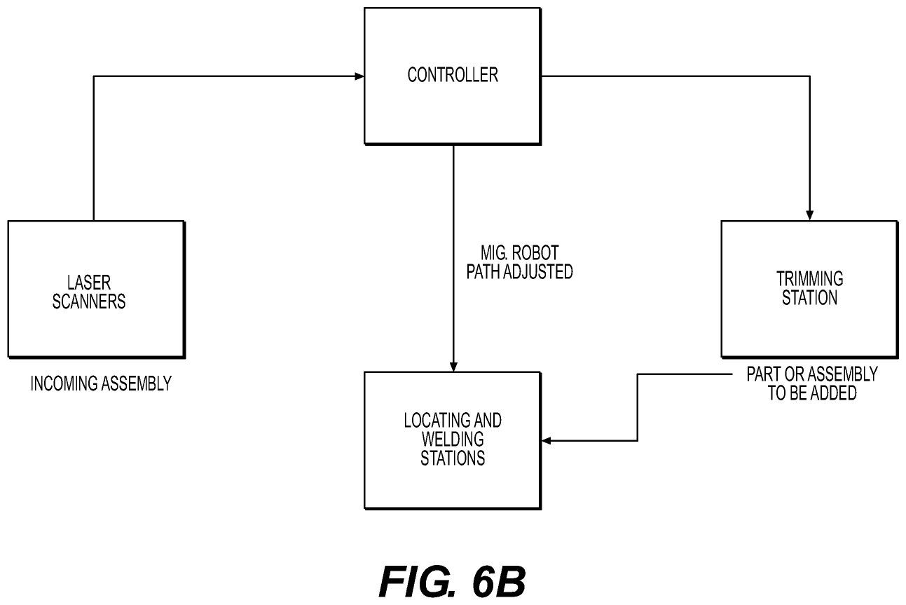

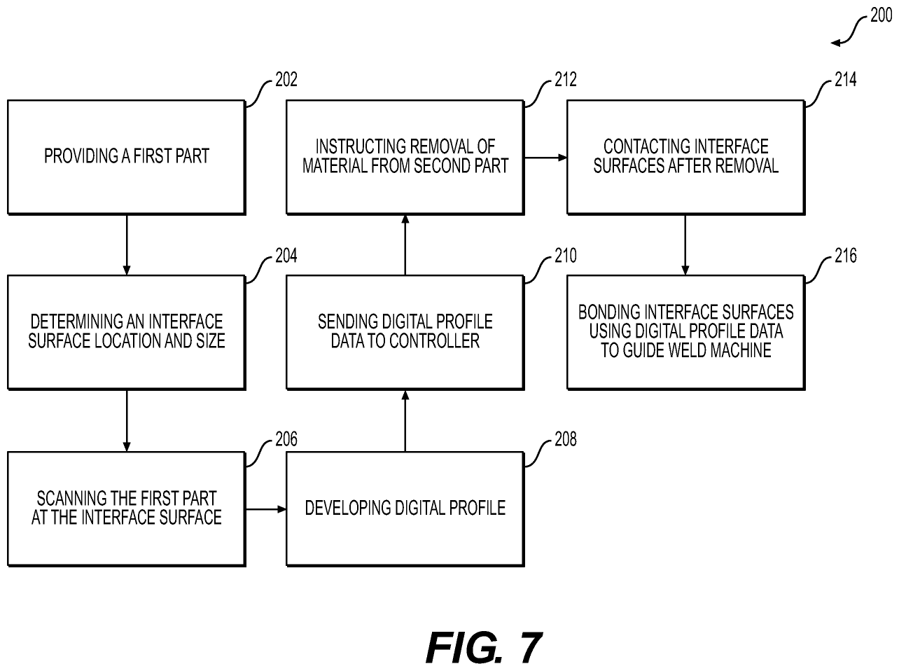

Referring now to FIG. 6A, a plan view illustrates a system 100 that includes a series of workstations for performing various steps to connect the two parts 22, 24 with a minimal gap between interface surfaces 26, 28. A part 22, 24 processed through the system 100 begins at flow line 102, where it is transferred to the scanning station 104. At the scanning station 104, the interface surface of at least one part 22, 24 is scanned to develop a digital profile 30. After being scanned, the digital profile 30 is sent to a trimming station 106 where it is used to shape the other part 22, 24 to have a corresponding interface surface. Once the part 22, 24 is shaped, both parts 22, 24 are moved to a welding station 108 and the digital profile 30 is used to direct a welding machine 44 to create a precise weld joint between interface surface. After bonding the parts together, the parts continue through the flow line 110, where other production steps may occur such as painting, cleaning, etc. In some circumstances, one part 22 may have a number of interface surfaces 26, 26′, 26″ for connecting to interfaces surfaces of one or more other parts. In such circumstances, while the part 22 is at the scanning station 104, a plurality of digital profiles 30, 30′, 30″ are determined that each represent the topography of one interface surface 26, 26′, 26″. These digital profiles 30, 30′, 30″ are then used to shape corresponding parts. Matching the corresponding interface surfaces can be streamlined via indicia on the parts, or placing the parts in sequential order of connection (e.g., left to right) as they are shaped. Similarly, in certain embodiments, the scanned part 22 can be moved to the connection station before or during the other parts are being shaped at the trimming station 106. In such scenarios, the shaping and connecting operations can performed at the same time and/or at the same work station so that as one part is shaped, it can be connected while another part is being shaped. FIG. 6B illustrates an example flow chart path of the system 100, wherein parts 22, 24 undergo laser scanning to develop a digital profile 30 that is stored in at least one controller 34 wherein it is accessible in both the trimming station 106 and the welding station 108.

In addition to the assemblies presented above, the subject invention further includes a method 200 of developing a digital profile of one part and shaping a second part in accordance with the digital profile data. The method begins by providing 202 a first part and determining 204 which locations of the first part will be interfacing and connecting with a second part. Step 204 includes taking the size and thickness of the second part into consideration to obtain the interface surface location. Next, the interface surface of the first part is scanned 206 and a digital profile of at least one interface surface is produced 208. The digital profile data is then sent 210 to a controller which instructs 212 a shaping/trimming assembly to remove material from a second interface surface of a second part until the topography of the first interface surfaces matches the topography of the second interface surface. Removal 212 may further be adjusted based on various factors, for example, the removal may include removing less material (for a zero or slightly less than zero gap) to establish a press-fit or more material (for a greater gap) to accommodate adhesive or some other intermediary substance between interface surfaces. After removal 212, the parts are contacted 214 at matching interface surfaces and bonded 216 together via instructions from the controller to guide a weld machine in accordance with the digital profile data.

It should be appreciated that the foregoing description of the embodiments has been provided for purposes of illustration. In other words, the subject disclosure it is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

1. An assembly for joining a first part to a second part, comprising:
a scanner for scanning a first interface surface on the first part to develop a digital profile, the first interface surface being located where the first part will be connected to the second part;
a shaping assembly for removing material from a second interface surface of the second part, the second interface surface being located where the second part will be connected to the first interface surface;
a processor; and
a memory device for receiving and storing the digital profile, the memory device further containing instructions that, when executed by the processor, cause the processor to:
instruct the shaping assembly to remove material from the second interface surface until it matches the digital profile of the first interface surface.

2. The assembly of claim 1, further including a welding assembly and wherein the processor is further caused to instruct the welding assembly to weld the first interface surface to the second interface surface by following the digital profile.

3. The assembly of claim 2, wherein the welding assembly includes a robotic arm being instructed by the processor.

4. The assembly of claim 3, wherein the welding assembly further includes an inert gas welding machine attached to and guided by the robotic arm.

5. The assembly of claim 1, wherein the shaping assembly includes a robotic arm being instructed by the processor.

6. The assembly of claim 5, wherein the shaping assembly further includes a shaping instrument attached to and guided by the robotic arm that provides one of milling or cutting.

7. The assembly of claim 6 further including a welding machine attached to the robotic arm to weld the first interface surface to the second interface surface by following the digital profile.

8. The assembly of claim 1, wherein the scanner includes a laser scanner.

9. The assembly of claim 1, further including a user interface for modifying the digital profile to effectuate more or less material removal by the shaping assembly.

10. The assembly of claim 9, wherein the memory device further includes a plurality of digital profile data for a plurality of first parts having different shapes that can be selected by the user interface.

11. The assembly of claim 1, wherein the first part interface surface includes a pair of first interface surfaces spaced from one another and the digital profile includes a digital profile for each interface surface.

12. The assembly of claim 11, wherein the second interface surface includes a pair of second interface surfaces spaced from one another and the processor further instructs the shaping assembly to remove material from each of the second interface surfaces until the second interface surfaces each match one of the digital profiles of the pair of first interface surfaces.

13. A method of joining a first part to a second part, comprising:
providing the first part and locating a first interface surface where the first part will be connected to the second part;
providing the second part and locating a second interface surface where the second part will be connected to the first interface surface;
scanning the first interface surface and developing a digital profile;
saving the digital profile on a memory device;
accessing the digital profile and instructing a shaping assembly to remove material from the second interface surface to form a shape corresponding to the digital profile;
contacting the first interface surface and the second interface surface; and
welding the first interface surface to the second interface surface.

14. The method of claim 13, wherein the step of welding the first interface surface to the second interface surface includes accessing the digital profile and instructing a welding assembly to weld along a pattern corresponding to the digital profile.

15. The method of claim 14, wherein the welding assembly includes a robotic arm and welding machine and the step of welding along a pattern includes moving the robotic arm to direct the welding machine.

16. The method of claim 13, wherein the step of shaping includes one of milling or cutting.

17. The method of claim 16, wherein the shaping assembly includes a robotic arm being instructed by the processor.

18. The method of claim 17, wherein the shaping assembly further includes a shaping instrument attached to and guided by the robotic arm.

19. The method of claim 18, wherein the welding assembly includes a welding machine attached to the robotic arm.

20. The method of claim 13, further including saving and storing the digital profile for repeated use.
